(19) United States
(12) Patent Application Publication
(10) Pub. No.: US 2025/0038683 A1
(43) Pub. Date: Jan. 30, 2025

(54) MOTOR CONTROL DETECTOR AND MOTOR CONTROLLING METHOD

(71) Applicant: Sentelic Corporation, Taipei City (TW)

(72) Inventor: Wen-Ting LEE, Taipei City (TW)

(21) Appl. No.: 18/516,902

(22) Filed: Nov. 21, 2023

(30) Foreign Application Priority Data
Jul. 25, 2023 (TW) 112127804

(51) Int. Cl. H02P 7/03

(52) U.S. Cl. CPC H02P 7/04

(57) ABSTRACT

A motor control detector is configured to drive a stator coil of a motor. Stator coil includes a first terminal and a second terminal. Motor control detector includes a controller, a switch circuit, and a current measurement circuit. Controller is configured to generate a plurality of driving signals. Switch circuit is coupled to controller, first terminal and second terminal of stator coil, and is configured to be conducted according to drive signals to transmit a current of a power supply to stator coil so as to generate an induced current according to a change of a magnetic field of stator coil. Current measurement circuit is coupled to control circuit and switch circuit, and is configured to receive induced current. Controller is configured to adjust driving signals according to induced current so as to control switch circuit according to driving signals to form circuit loops to drive stator coil.

### CROSS-REFERENCE TO RELATED APPLICATION

This application claims priority to Taiwan Application Serial Number 112127804, filed Jul. 25, 2023, which is herein incorporated by reference in its entirety.

### BACKGROUND

### Field of Invention

The present disclosure relates to an electronic device and a control method. More particularly, the present disclosure relates to a motor control detector and a motor controlling method.

### Description of Related Art

Conventional motor controllers generally determine a current position of a rotor magnetic poles based on a Hall effect sensor, determine whether to commutate stator coils of motor according to a current position, and then control continuous rotation of a rotor. However, manufacturing cost and time cost of a Hall effect sensor occupy most of cost of a motor.

For the foregoing reason, there is a need to provide a suitable motor control detector and a motor controlling method to solve the problems of the prior art.

### SUMMARY

One aspect of the present disclosure provides a motor control detector. The motor control detector is configured to drive a stator coil of a motor. The stator coil includes a first terminal and a second terminal. The motor control detector includes a controller, a switch circuit and a current measurement circuit. The controller is configured to generate a plurality of driving signals. The switch circuit is coupled to the controller, the first terminal and the second terminal of the stator coil, and is configured to be conducted according to the driving signals to transmit a current of a power supply to the stator coil so as to generate an induced current according to a change of a magnetic field of the stator coil. The current measurement circuit is coupled to the switch circuit and the controller, and is configured to receive the induced current. The controller is configured to adjust the driving signals according to the induced current so as to control the switch circuit according to the driving signals to form circuit loops to drive the stator coil.

Another aspect of the present disclosure provides a motor controlling method. The motor controlling method is adapted to a motor control detector. The motor control detector includes a controller and a switch circuit. The controller is coupled to the switch circuit. The switch circuit is configured to drive a motor. The switch circuit includes a forward circuit and a reverse circuit. The motor controlling method includes following steps: conducting a first one of the forward circuit and the reverse circuit so as to make the stator coil generate a magnetic field to attract a rotor of the motor to a specified position; conducting a second one of the forward circuit and the reverse circuit, so as to make the stator coil generate a reverse magnetic field corresponding to the magnetic field, so that the rotor is converted into a rotating state along a direction at the specified position; generating an induced current in response to the rotating state of the rotor by the switch circuit; determining whether a change value of the induced current exceeds at least one current preset threshold by the controller; and generating at least one driving signal to conduct the first one of the forward circuit and the reverse circuit by the controller to commutate the stator coil so that the rotor maintains the rotating state in the direction if the change value of the induced current is determined to exceed the at least one current preset threshold.

In view of the aforementioned shortcomings and deficiencies of the prior art, the present disclosure provides a motor control detector and a motor controlling method to determine a phase commutation of a stator coil of a motor through an induced current of a motor control detector, so as to control a rotor and replace a Hall effect sensor. Therefore, a motor control detector of the present disclosure does not need a Hall effect sensor to detect a current position of a rotor, thereby reducing a structural manufacturing cost of a motor.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a motor control detector according to some embodiments of the present disclosure;

FIG. 2 depicts a schematic diagram of a motor controlled by a motor control detector according to some embodiments of the present disclosure;

FIG. 3 depicts a flow chart of a motor controlling method according to some embodiments of the present disclosure;

FIGS. 4A and 4B depict schematic diagrams of induced currents of a motor control detector according to some embodiments of the present disclosure;

FIG. 5 depicts a schematic diagram of an induced current of a motor control detector according to some embodiments of the present disclosure; and

FIG. 6 depicts a schematic diagram of an induced current of a motor control detector according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

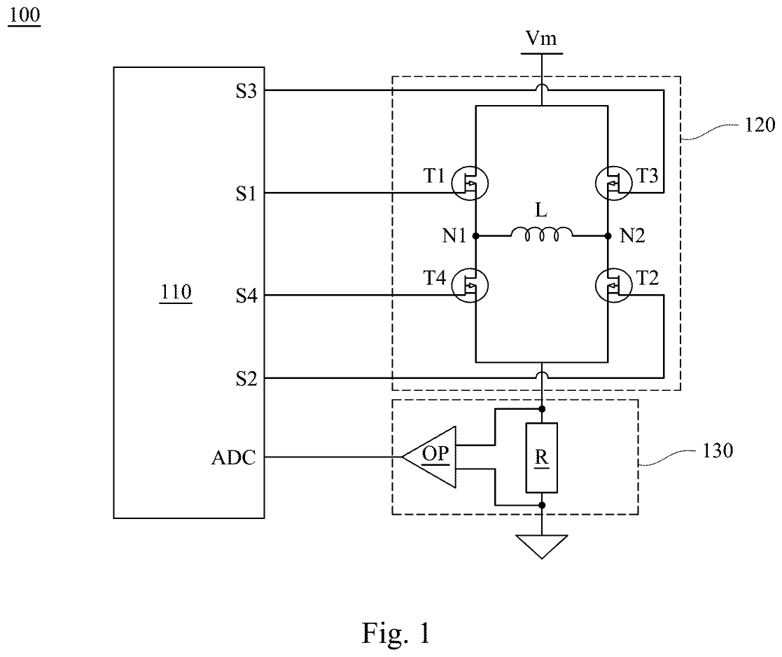

FIG. 1 depicts a schematic diagram of a motor control detector 100 according to some embodiments of the present disclosure. In some embodiments, the motor control detector 100 is configured to drive a stator coil L of a motor. The stator coil L includes a first terminal N1 and a second terminal N2. The motor control detector 100 includes a controller 110, a switch circuit 120 and a current measurement circuit 130. The switch circuit 120 is coupled to the controller 110. The current measurement circuit 130 is coupled to the controller 110 and the switch circuit 120.

In some embodiments, the controller 110 is configured to generate a plurality of driving signals (e.g.: a driving signal S1 to a driving signal S4). The switch circuit 120 is coupled to the controller 110, a first terminal N1 and a second terminal N2 of the stator coil L, and is configured to be conducted according to the driving signals to transmit a current of a power supply Vm to the stator coil L, so as to generate an induced current according to a change of a magnetic field of the stator coil L. The current measurement circuit 130 is configured to receive the induced current. The controller 110 is configured to adjust the driving signals according to the induced current, so as to control the switch circuit 120 according to the driving signals to form circuit loops to drive the stator coil L.

In some embodiments, the switch circuit 120 includes a transistor T1 to a transistor T4. In some embodiments, the controller 110 is respectively configured to provide the driving signal S1 to the driving signal S4, to drive the transistor T1 to transistor T4.

In some embodiments, please refer to FIG. 1, the switch circuit 120 includes a forward circuit and a reverse circuit. The forward circuit of the switch circuit 120 includes a transistor T1 and a transistor T2. The reverse circuit of the switch circuit 120 includes a transistor T3 and a transistor T4. Please start from a top side and a right side of a component in the figure as a first terminal, the transistor T1 includes a first terminal, a second terminal and a control terminal. In some embodiments, switch circuit 120 includes a H-bridge circuit.

In some embodiments, the first terminal of the transistor T1 is coupled to a power supply Vm. The second terminal of the transistor T1 is coupled to the first terminal N1 of the stator coil L. The control terminal of the transistor T1 is coupled to the controller 110, and is configured to be conducted in response to the driving signal S1.

In some embodiments, the transistor T2 includes a first terminal, a second terminal and a control terminal. The first terminal of the transistor T2 is coupled to the second terminal N2 of the stator coil L. The second terminal of the transistor T2 is coupled to the current measurement circuit 130. The control terminal of the transistor T2 is coupled to the controller 110, and is configured to be conducted in response to the driving signal S2.

In some embodiments, the transistor T3 includes a first terminal, a second terminal and a control terminal. The first terminal of the transistor T3 is coupled to the power supply Vm. The second terminal of the transistor T3 is coupled to the second terminal N2 of the stator coil L. The control terminal of the transistor T3 is coupled to the controller 110, and is configured to be conducted in response to the driving signal S3.

In some embodiments, please refer to FIG. 1, the transistor T4 includes a first terminal, a second terminal and a control terminal. The first terminal of the transistor T4 is coupled to the first terminal N1 of the stator coil L. The second terminal of the transistor T4 is coupled to the current measurement circuit 130. The control terminal of the transistor T4 is coupled to the controller 110, and is configured to be conducted in response to the driving signal S4.

In some embodiments, the transistor T1 and the transistor T4 are not be conducted at the same time. In some embodiments, the transistor T2 and the transistor T3 are not be conducted at the same time. It should be noted that if the transistor T1 and the transistor T4 or the transistor T2 and the transistor T3 are closed at the same time, a positive pole and a negative pole of the power supply Vm will be short-circuited, thereby causing danger to the power supply Vm and switching elements (i.e.: the transistor T1 to the transistor T4).

In some embodiments, a transistor type of the transistor T1 and the transistor T3 is different from a transistor type of the transistor T2 and the transistor T4.

In some embodiments, the transistor T1 and the transistor T3 are P-type Metal-Oxide-Semiconductor Field-Effect Transistor (PMOS). The transistor T2 and the transistor T4 are N-type Metal-Oxide-Semiconductor Field-Effect Transistor (NMOS).

In some embodiments, the current measurement circuit 130 includes a shunt resistor R and an amplifier OP. The shunt resistor R is configured to detect a potential difference between two terminals of the shunt resistor R, and use Ohm's law to measure a current value flowing through a circuit. The amplifier OP is configured to amplify a signal value of a current to be input a input pin ADC of the controller 110.

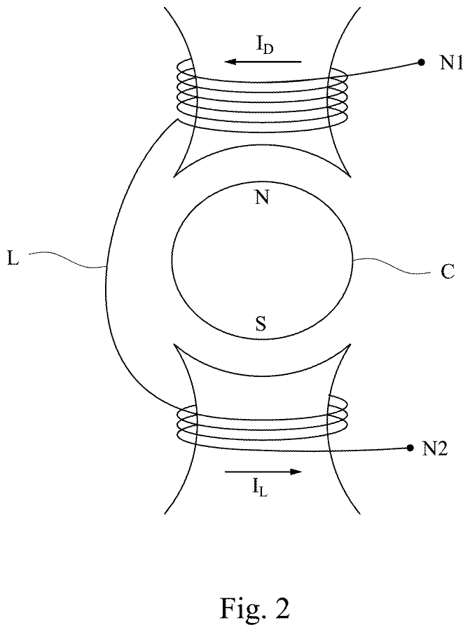

FIG. 2 depicts a schematic diagram of a motor controlled by the motor control detector 100 in FIG. 1 according to some embodiments of the present disclosure. In some embodiments, the motor includes the stator coil L and a rotor C. The rotor C usually has a centrosymmetric structure (i.e. a single-phase motor).

In some embodiments, please refer to FIG. 1 and FIG. 2, the stator coil L is configured to receive a current ID of the power supply Vm from the first terminal N1 to generate a magnetic field. When the rotor C changes according to the magnetic field of the stator coil L and is in a rotating state, the stator coil L is also affected by a magnetic field of the rotor C and correspondingly generates an induced current I_{L}.

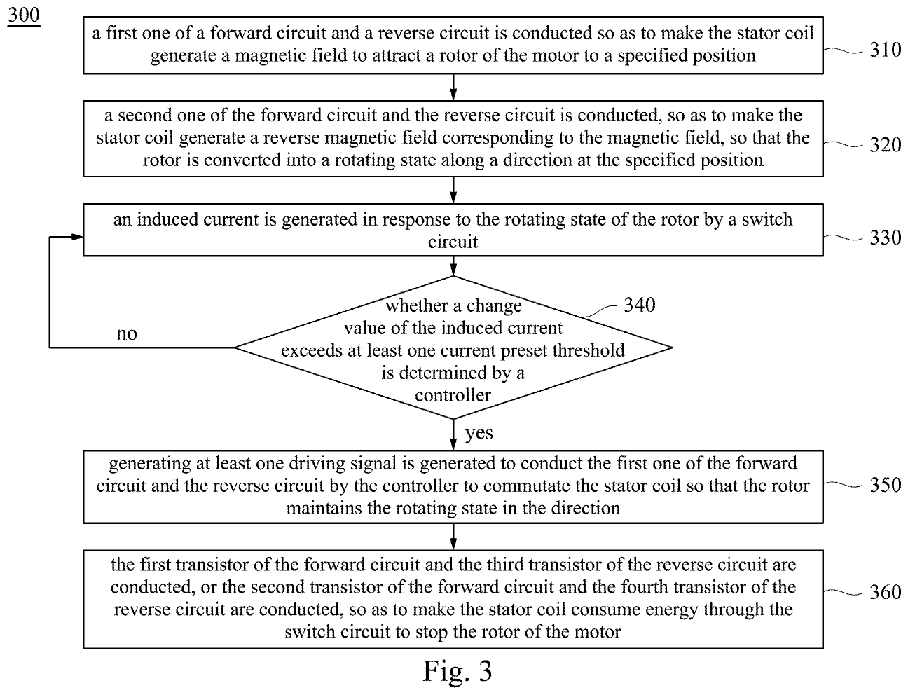

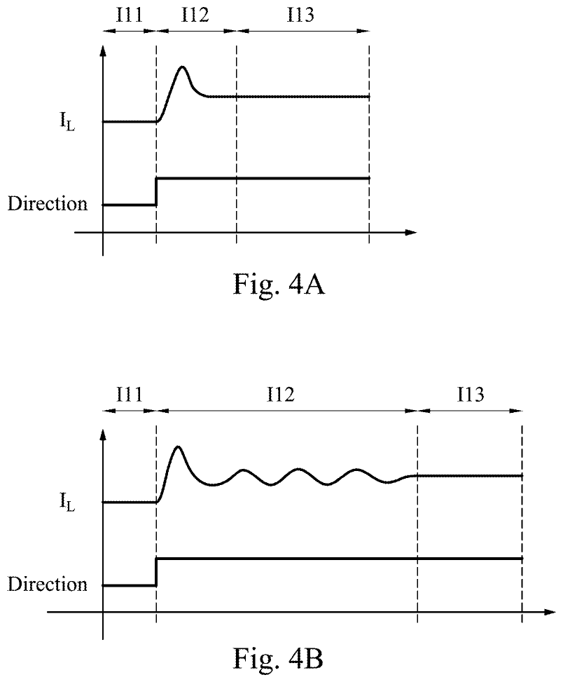

In some embodiments, in order to facilitate the understanding of operations of the motor control detector 100, please refer FIG. 1 to FIG. 6. FIG. 3 depicts a flow chart of a motor controlling method 300 according to some embodiments of the present disclosure. FIG. 4A to FIG. 6 depict a schematic diagram of induced currents of the motor control detector 100 in FIG. 1 according to some embodiments of the present disclosure. In some embodiments, the motor controlling method 300 can be executed by the motor control detector 100.

In step 310, please refer FIG. 1 to FIG. 3, the controller 110 is configured to conduct a first one of the forward circuit and the reverse circuit of the switch circuit 120 so as to make the stator coil L generate a magnetic field to attract the rotor C of the motor to a specified position.

For example, the controller 110 is configured to generate the driving signal S1 and the driving signal S2 to conduct the transistor T1 and the transistor T2 of the forward circuit of the switch circuit 120 so that the stator coil L of the motor generates a magnetic field, and then attract the rotor C of the motor to a specified position.

For example, the controller 110 is configured to generate the driving signal S3 and the driving signal S4 to conduct the transistor T3 and the transistor T4 of the reverse circuit of the switch circuit 120 so that the stator coil L of the motor generates a magnetic field, and then attract the rotor C of the motor to a specified position. It should be noted that the step 310 is a step of returning the rotor C of the motor to zero.

In step 320, please refer to FIG. 1 to FIG. 3, the controller 110 is configured to conduct a second one of the forward circuit and the reverse circuit so as to make the stator coil L generate a reverse magnetic field corresponding to the magnetic field so that the rotor C is converted into a rotating state in a clockwise direction or a counterclockwise direction at the specified.

For example, following the first example of the aforementioned step 310, since the transistor T1 and the transistor T2 of the forward circuit of the switch circuit 120 are first conducted according to the driving signal S1 and the driving signal S2 to make the stator coil L of the motor generate the magnetic field, and then attract the rotor C of the motor to the specified position.

Then, the driving signal S3 and the driving signal S4 are generated by the controller 110 to conduct the transistor T3 and the transistor T4 of the reverse circuit of the switch circuit 120 so that the stator coil L generates a reverse magnetic field corresponding to the magnetic field, thereby making the rotor C switches to a rotating state in a clockwise or counterclockwise direction at a specified position. Since an operation of the second example in step 310 is similar to the operation of the first example, and detail repetitious are omitted here.

In step 330, please refer to FIG. 1 to FIG. 3, the switch circuit 120 responds to the rotating state of the rotor C to generate an induced current I_{L}, and then the current measurement circuit 130 detects the induced current I_{L} to output a feedback signal to the controller 110.

For example, please refer to FIG. 1 to FIG. 4A, following the above step 310, in a stage 111, the rotor C is in a stationary state, the induced current I_{L} maintains a static state. Then, in a stage 112, the first one of the forward circuit and the reverse circuit of the switch circuit 120 is conducted by the controller 110, so that the stator coil L of the motor generates the magnetic field, thereby causing the rotor C of the motor to rotate, and the induction current I_{L} of the stator coil L is changed. Next, in a stage 113, the stator coil L of the motor generates the magnetic field to attract the rotor C of the motor to the specified position and stabilize the rotor C, and the induced current I_{L} returns to the static state.

Compared with the induced current I_{L} in the stage 112 of FIG. 4A, the induced current I_{L} in the stage 112 of FIG. 4B takes more time to recover to a static state. The stage 112 in FIG. 4A and FIG. 4B both represent the rotor C is rotating.

In step 340, please refer to FIG. 1 to FIG. 3, the controller 110 is configured to determine whether a change value of the induced current I_{L} exceeds a current preset threshold, so as to confirm a time point when the stator coil L performs commutation, so that the rotor C continues to rotate. If it is determined that the change value of the induced current I_{L} does not exceed the current preset threshold, the switch circuit 120 is configured to execute the step 310, and the controller 110 is configured to detect the induced current I_{L} continuously. If it is determined that the change value of the induced current I_{L} exceeds the current preset threshold, the switch circuit 120 is configured to execute the step 350.

For example, following the example of the aforementioned step 320, if it is determined that the change value of the induced current I_{L} does not exceed the current preset threshold, the controller 110 is further configured to generate the driving signal S3 and the driving signal S4 to conduct the transistor T3 and the transistor T4 of the reverse circuit of the switch circuit 120, to maintain the reverse magnetic field of the stator coil L. An operation in the opposite direction is as described above, and detail repetitious are omitted here.

In step 350, please refer to FIG. 1 to FIG. 3, the controller 110 is configured to generate at least one driving signal (i.e. the driving signal S1 to driving signal S4) to alternately conduct the forward circuit and the reverse circuit of the switch circuit 120, so as to make the stator coil L commutate in sequence to keep the rotor C rotating in original clock direction.

For example, following the example of the aforementioned step 320, if it is determined that the change value of the induced current I_{L} exceeds the current preset threshold, the controller 110 is further configured to generate the driving signal S1 and the driving signal S2 to conduct the transistor T1 and the transistor T2 of the forward circuit of the switch circuit 120, so as to make the stator coil L generate the magnetic field, to keep the rotor C rotating in the in original clock direction. An operation in the opposite direction is as described above, and detail repetitious are omitted here.

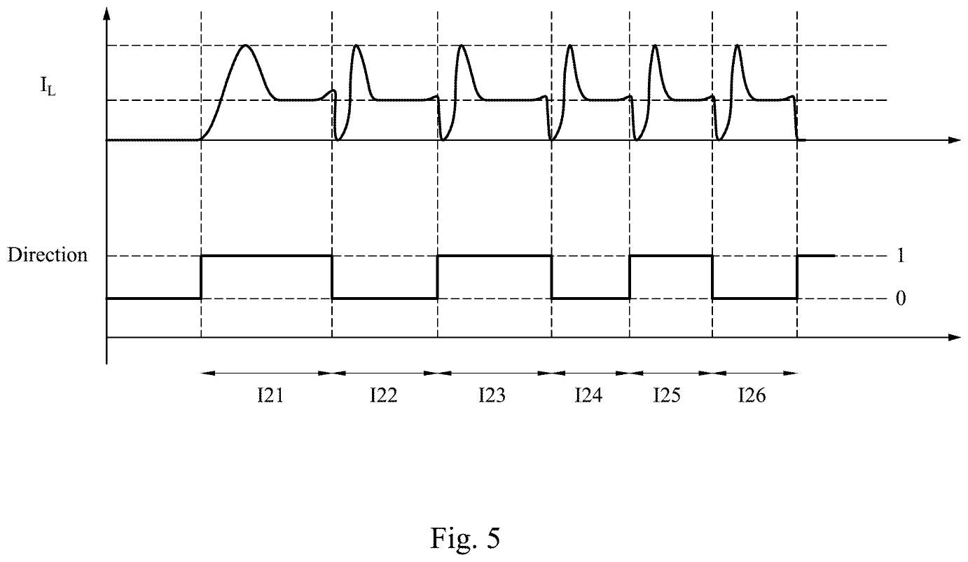

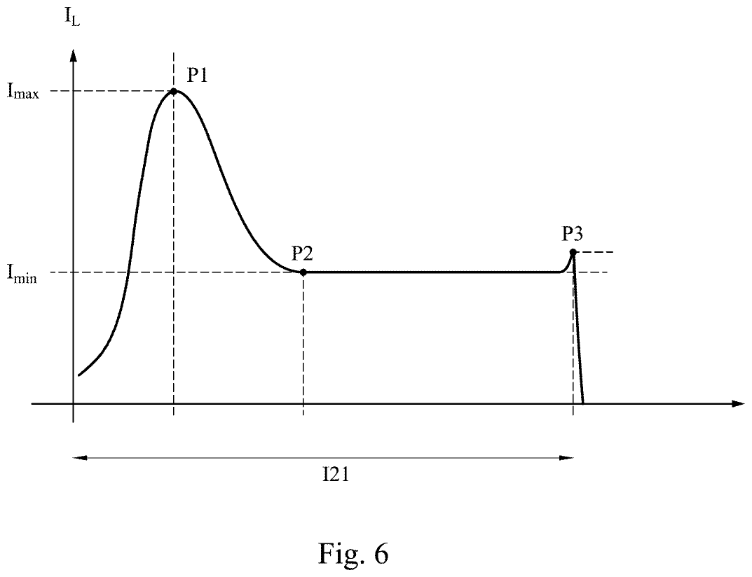

In some embodiments, please refer to FIG. 5 and FIG. 6, FIG. 5 is a change diagram of the induced current I_{L} of a continuous commutation of the motor. FIG. 5 is composed of stage 121 to stage 126. There are a large peak change and a small peak change in each stage. FIG. 6 is an enlarged view of the induced current I_{L} corresponding to stage 121 in FIG. 5. It should be noted that the larger peak is a change of the induced current I_{L} is just after commutation. The smaller peak is a time point for determining a commutation of the rotor C of the above motor.

Then, the controller 110 is configured to detect a current maximum value Imax and a current minimum value Imin of the induced current I_{L}. Furthermore, the controller 110 is configured to calculate a current difference between the current maximum value Imax and the current minimum value Imin (i.e. a distance between a position P1 and a position P2). Next, the controller 110 is configured to generate at least one current preset threshold according to the current difference and a proportional value.

Afterwards, when the induced current I_{L} changes to a position P3, the controller 110 is configured to determine whether the change value of the induced current I_{L} exceeds the current preset threshold, so as to confirm the time point when the stator coil L performs commutation. It should be noted that if the induced current I_{L} changes to the position P3, and the controller 110 is configured to determine that the change value of the induced current I_{L} exceeds the current preset threshold, the controller 110 is configured to output the driving signals S1-S4 in real time at the position P3 to control the switch circuit 120 perform commutation.

In some embodiments, the current preset threshold can be stored in the controller 110, or can be calculated according to the proportional value and the current difference between the current maximum value Imax and the current minimum value Imin. The controller 110 is configured to select one of the current preset thresholds generated in the aforementioned two different aways according to the change value of the induced current I_{L} as the current preset threshold when the controller 110 is configured to determine.

For example, if the current difference between the current maximum value Imax and the current minimum value Imin is 1 milliamp (mA), a value proportional to 2 of the current difference can be taken as the current preset threshold, that is, 0.2 milliamps (mA) as the current preset threshold. It should be noted that the current preset threshold and the proportional value can be designed according to actual needs, and are not limited by the embodiment of the present disclosure. It should be further explained that the controller 110 needs to find the current maximum value Imax and the current minimum value Imin before determining whether the change value of the induced current I_{L} exceeds the current preset threshold.

In step 360, please refer to FIG. 1 to FIG. 3, the transistor T1 of the forward circuit of the switch circuit 120 and the transistor T3 of the reverse circuit of the switch circuit 120 are conducted by the controller 110, or the second transistor T2 of the forward circuit of the switch circuit 120 and the transistor T4 of the reverse circuit of the switch circuit 120 are conducted by the controller 110, so that the stator coil L consumes energy through the switch circuit 120 to stop the rotor C of the motor.

In some embodiments, the first one of the forward circuit and the reverse circuit of the switch circuit 120 is conducted by the controller 110 to make the stator coil L generate the magnetic field again, and then attract the rotor C to the specified position, so as to ensure the rotor C is in the static state. It should be note that if a circuit conducted when the rotor C is stopped is the forward circuit of the switch circuit 120, a circuit conducted when the rotor C of the motor returns to zero may be the same as or different from the forward circuit of the switch circuit 120 (i.e.: the reverse circuit of the switch circuit 120).

In some embodiments, please refer to FIG. 3, FIG. 4A and FIG. 4B, the controller 110 is configured to determine whether the change value of the induced current I_{L} maintains a certain value, and then determine whether the rotor C is in the static state.

If the induced current I_{L} maintains a certain value in the stage 113, the controller 110 is configured to determine that the rotor C is in the static state. If the induced current I_{L} is not a certain value in the stage 112, the controller 110 is configured to determine that the rotor C is still in an unstable rotation state.

Based on the aforementioned embodiments, the present disclosure provides a motor control detector and a motor controlling method to determine a commutation of a stator coil of a motor through an induced current of the motor control detector so as to control the rotor, and then replace the Hall sensor. Therefore, the motor control detector of the present disclosure does not need a Hall sensor to detect a current position of a rotor, thereby reducing structural manufacturing cost of a motor. In addition, in the present disclosure, a time point of commutation is determined by a change value of an induced current of a motor control detector and the current preset threshold.

Certain terms are used in the specification and the claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, in the description herein and throughout the claims that follow, the phrase “and/or” includes any and all combinations of one or more of the associated listed items. Unless the context clearly dictates otherwise, the singular terms used herein include plural referents.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A motor control detector, wherein the motor control detector is configured to drive a stator coil of a motor, wherein the stator coil includes a first terminal and a second terminal, wherein the motor control detector comprises:
a controller, configured to generate a plurality of driving signals;
a switch circuit, coupled to the controller, the first terminal and the second terminal of the stator coil, and configured to be conducted according to the driving signals to transmit a current of a power supply to the stator coil, so as to generate an induced current according to a change of a magnetic field of the stator coil; and
a current measurement circuit, coupled to the switch circuit and the controller, and configured to receive the induced current, wherein the controller is configured to adjust the driving signals according to the induced current so as to control the switch circuit according to the driving signals to form circuit loops to drive the stator coil.

2. The motor control detector of claim 1, wherein the switch circuit comprises:
a forward circuit:
a first transistor, comprising:
a first terminal, coupled to the power supply;
a second terminal, coupled to the first terminal of the stator coil; and
a control terminal, coupled to the controller; and
a second transistor, comprising:
a first terminal, coupled to the second terminal of the stator coil;
a second terminal, coupled to the current measurement circuit; and
a control terminal, coupled to the controller.

3. The motor control detector of claim 2, wherein the switch circuit further comprises:
an reverse circuit:
a third transistor, comprising:
a first terminal, coupled to the power supply;
a second terminal, coupled to the second terminal of the stator coil; and
a control terminal, coupled to the controller;
a fourth transistor, comprising:
a first terminal, coupled to the first terminal of the stator coil;
a second terminal, coupled to the current measurement circuit; and
a control terminal, coupled to the controller.

4. The motor control detector of claim 3, wherein the switch circuit comprises a H-bridge circuit.

5. The motor control detector of claim 3, wherein the controller is further configured to conduct a first one of the forward circuit and the reverse circuit according to the driving signals, so as to make the stator coil generate a magnetic field to attract a rotor of the motor to a specified position.

6. The motor control detector of claim 5, wherein the controller is further configured to conduct a second one of the forward circuit and the reverse circuit according to the driving signals, so as to make the stator coil generate a reverse magnetic field corresponding to the magnetic field to rotate the rotor of the motor.

7. The motor control detector of claim 6, wherein the controller is further configured to alternately conduct the forward circuit and the reverse circuit according to the driving signals, so as to seq sequentially commutate the stator coils according to the induced current to continuously rotate the rotor of the motor.

8. The motor control detector of claim 7, wherein the controller is further configured to conduct the first transistor of the forward circuit and the third transistor of the reverse circuit according to the driving signals, or to conduct the second transistor of the forward circuit and the fourth transistor of the reverse circuit according to the driving signals, so as to make the stator coil consume energy through the switch circuit to stop the rotor of the motor.

9. The motor control detector of claim 8, wherein the controller is further configured to determine whether a change value of the induced current exceeds a current preset threshold, wherein if the change value of the induced current is determined to exceed the current preset threshold, wherein the controller is further configured to conduct the first one of the forward circuit and the reverse circuit according to the driving signals to commutate the stator coil.

10. The motor control detector of claim 9, wherein if the change value of the induced current is determined not to exceed the current preset threshold, wherein the controller is configured to conduct the second one of the forward circuit and the reverse circuit according to the driving signals to maintain the reverse magnetic field of the stator coil.

11. A motor controlling method, adapted to a motor control detector, wherein the motor control detector comprises a controller and a switch circuit, wherein the controller is coupled to the switch circuit, wherein the switch circuit is configured to drive a motor, wherein the switch circuit comprises a forward circuit and a reverse circuit, wherein the motor controlling method comprises:
conducting a first one of the forward circuit and the reverse circuit so as to make a stator coil generate a magnetic field to attract a rotor of the motor to a specified position;
conducting a second one of the forward circuit and the reverse circuit, so as to make the stator coil generate a reverse magnetic field corresponding to the magnetic field, so that the rotor is converted into a rotating state along a direction at the specified position;
generating an induced current in response to the rotating state of the rotor by the switch circuit;
determining whether a change value of the induced current exceeds at least one current preset threshold by the controller; and
generating at least one driving signal to conduct the first one of the forward circuit and the reverse circuit by the controller to commutate the stator coil so that the rotor maintains the rotating state in the direction if the change value of the induced current is determined to exceed the at least one current preset threshold.

12. The motor controlling method of claim 11, further comprising:
conducting the second one of the forward circuit and the reverse circuit to maintain the reverse magnetic field of the stator coil if the change value of the induced current is determined not to exceed the at least one current preset threshold.

13. The motor controlling method of claim 11, wherein the forward circuit comprises a first transistor and a second transistor, wherein the reverse circuit comprises a third transistor and a fourth transistor, wherein the first transistor and the fourth transistor are coupled to a first terminal of the stator coil, wherein the second transistor and the third transistor are coupled to a second terminal of the stator coil.

14. The motor controlling method of claim 13, further comprising:
conducting the first transistor of the forward circuit and the third transistor of the reverse circuit, or conducting the second transistor of the forward circuit and the fourth transistor of the reverse circuit, so as to make the stator coil consume energy through the switch circuit to stop the rotor of the motor.

15. The motor controlling method of claim 13, wherein the first transistor and the fourth transistor are not conducted at a same time, wherein the second transistor and the third transistor are not conducted at a same time.

16. The motor controlling method of claim 13, wherein a first transistor type of each of the first transistor and the third transistor is different from a second transistor type of each of the second transistor and the fourth transistor.

17. The motor controlling method of claim 11, wherein determining whether the change value of the induced current exceeds the at least one current preset threshold by the controller comprises:
detecting a current maximum value and a current minimum value of the induced current by the controller;
calculating a current difference between the current maximum value and the current minimum value by the controller; and
generating the at least one current preset threshold according to the current difference and a proportional value by the controller.

18. The motor controlling method of claim 17, wherein the controller is configured to store a first current preset threshold and a second current preset threshold, wherein determining whether the change value of the induced current exceeds the at least one current preset threshold by the controller further comprises:
selecting one of the first current preset threshold and the second current preset threshold as the at least one current preset threshold according to the change value of the induced current by the controller.

19. The motor controlling method of claim 14, further comprising:
conducting the first one of the forward circuit and the reverse circuit, so that the stator coil generates the magnetic field again to attract the rotor to the specified position, so as to ensure that the rotor is in a static state.

20. The motor controlling method of claim 19, further comprising:
determining whether the change value of the induced current maintain a certain value by the controller to determine whether the rotor is in the static state.
